(19) United States
(12) Patent Application Publication
(10) Pub. No.: US 2025/0388518 A1
(43) Pub. Date: Dec. 25, 2025

(54) OXIDATION PROTECTIVE COATING FOR DIBORIDE BASED ULTRA-HIGH TEMPERATURE CERAMICS, BASED ON ELEMENTAL ALUMINUM AND ALUMINA MIXTURES

(71) Applicants: Deutsches Zentrum für Luft- und Raumfahrt e.V., Bonn (DE); The Curators of the University of Missouri, Columbia, MO (US)

(72) Inventors: Jan Erik FÖRSTER, Köln (DE); Ravisankar NARAPARJU, Troisdorf (DE); Peter MECHNICH, Bad Dürkheim (DE); William FAHRENHOLTZ, Rolla, MO (US); Gregory HILMAS, Rolla, MO (US)

(21) Appl. No.: 19/245,646

(22) Filed: Jun. 23, 2025

Related U.S. Application Data
(60) Provisional application No. 63/663,221, filed on Jun. 24, 2024.

(51) Int. Cl. C04B 41/87; C04B 41/00; C04B 41/45; C04B 41/89

(52) U.S. Cl. CPC C04B 41/87; C04B 41/009; C04B 41/4539; C04B 41/89

(57) ABSTRACT

The present application refers to a protective coating for diboride based Ultra-High Temperature Ceramics and a method for preparing said coating. The coating is applied as alumina mixture, i.e. a mixture of elemental aluminum and aluminum oxide, and may be applied as a slurry directly on the diboride based ceramic materials, preferably zirconium diboride, hafnium diboride or mixtures thereof, for ultra-high temperature applications.

### CROSS-REFERENCE TO RELATED APPLICATION

This application claims the benefit of priority of U.S. provisional patent application No. 63/663,221 filed on Jun. 24, 2024, and entitled “Oxidation protective coating for diboride based Ultra-High Temperature Ceramics, based on elemental aluminum and alumina mixtures,” the contents of which are incorporated in full by reference herein.

### TECHNICAL FIELD

The present application refers to a protective coating for diboride based Ultra-High Temperature Ceramics and a method for preparing said coating. The coating comprises a mixture of elemental aluminum and alumina mixtures and may be applied as a slurry directly on the diboride based ceramic materials, preferably zirconium diboride, hafnium diboride or mixtures thereof, for ultra-high temperature applications.

### BACKGROUND

The demand for more efficient materials at elevated temperatures is ever-increasing and the availability of such materials is scarce. But new generation super alloys, which can tolerate high temperatures and high stresses, are not able the withstand harsh environments above 1500° C. in oxidizing atmosphere. Ultra-high temperature ceramics (UHTCs) are a material group, which comprises ceramics with unusual properties like a melting point above 3000° C. and thermal conductivities higher than 50 W/mK at 2000° C. These properties make UHTCs very attractive for applications like fuel for modern nuclear fission reactors, first wall materials for nuclear fusion reactors, and collectors for concentrated solar power. ZrB2 is one of the most studied UHTCs, since it has one of the lowest theoretical densities (6.085 g/cm³) of all diboride based UHTCs. Unfortunately, ZrB2 oxidizes easily in oxidative atmospheres above 1000° C., following oxygen diffusion controlled parabolic oxidation kinetics with increased rate constant. At low temperature regime, the oxidation leads to the formation of crystalline zirconia (ZrO2) and a liquid layer of boria (B2O3).

The layer of B2O3 prevents the diffusion of oxygen to the reaction front of ZrB2, a long as it remains at the surface. Since liquid B2O3 exhibits a high evaporation rate above 1000° C., it evaporates with respect to the time in the intermediate and high temperature regimes and leaves a porous unprotective solid ZrO2 oxide scale. Phase transition of ZrO2 from a monoclinic to a tetragonal crystal structure appears at 1120° C. and initiates the formation of pores and cracks within the solid ZrO2-scale due to a volume contraction of about 7 vol %. The defects within the oxide scale speed up oxygen diffusion through the scale to the reaction front of ZrB2. Several studies focused on diboride based UHTCs composites or fiber reinforced UHTCMCs to improve the oxidation resistance and mechanical properties. The addition of several materials, like niobium, tungsten carbide or silicon carbide, show positive effects.

The true potential of UHTCs with improved oxidation resistance is still unknown. Therefore, this approach shows considerable potential for the future, improving the oxidation resistance of UHTCs and UHTCMCs without changing the fundamental material properties of the diboride due to major additions. Modern coatings can serve as diffusion barrier coatings (DBC) already. Coatings can be applied via various processes. Each process leads to different microstructures, densities, different adhesion mechanisms and more, which affects the coating performance, even when they have similar chemical composition. Previous studies confirmed the functionality of metallic Nb-coatings and ceramic HfO2-coatings on ZrB2 by means of PVD-magnetron sputtering. The oxidation was reduced by ˜23% in scale thickness for exposure times of up to 4 h at 1500° C. The data already revealed that the functionality of a coating on UHTCs is superior to UHTC composites.

Like UHTC composites, coatings are supposed to react with the oxidation products at the surface to form more stable refractory products. Alumina (Al2O3) is a refractory material with a melting point at ˜2072° C. Both binary ceramic compositions, Al2O3-ZrB2 and Al2O3-ZrO2, are inert and will not react with each other. Therefore, Al2O3 was not in the focus of interest.

CN1587188A discloses a preparation method of synthesizing a ZrB2-Al2O3 ceramic powder in one step. The active metal reductant and cheap oxide as material are synthesized into high purity composite ZrB2-Al2O3 ceramic powder. Specifically, the process includes mixing ZrO2, B2O3 and Al powder, molding, igniting to combust in a self-propagating high temperature synthesis apparatus under the protection of argon, and crushing the combustion product to obtain the high purity composite ZrB2-Al2O3 ceramic powder.

WO2003011781A2 discloses Al2O3-rare earth oxide-ZrO2/HfO2 materials and methods of making them as a ceramic material and/or glass.

CN102912305 discloses a preparation method for an amorphous Al2O3 and superfine nanocrystalline-coated ZrO2 compound coating material and relates to amorphous superfine nanocrystalline coating materials. The preparation method comprises the steps as follows: preprocessing a substrate; conducting the reactive sputtering deposition on a thermodynamic unsteady-state ZrAlN precursor film material; and conducting the annealing treatment on the ZrAlN precursor film material. The amorphous Al2O3 and superfine nanocrystalline-coated ZrO2 compound coating material with controllable coating degree and thickness is prepared by controlling various process parameters.

EP0334689A1 relates to an article made of ceramic material produced by fusing and casting in a mold a composition based on alumina, zirconia, silica and an alkali metal oxide.

CN102417375A discloses a charcoal/charcoal composite material SiC/ZrB2-SiC/SiC coating and a preparation method thereof. The composite material comprises SiC/ZrB2-SiC/SiC, including an inner coating and an outer coating; the inner coating is SiC, and its components include 65-75 wt % Si, 15-20 wt % C and 10-15 wt % Al2O3, the Si, C and Al2O3 are all powder materials; characterized in that also includes an intermediate coating, and the thickness of the inner coating is 20 to 50 μm, the outer coating the thickness is 30 to 80 μm, the thickness of the intermediate coating is 50 to 80 μm; the intermediate coating is ZrB2-SiC coating, and the ZrB2 and SiC are 75 to 90 wt % and 25 to 10 wt %; the outer coating is CVD SiC coating.

CN102515850A discloses a carbon/carbon composite material ultra-high temperature oxidation resistant coating. The coating comprises the following components, by volume, 40-60% of ZrB2, 15-25% of SiC, 15-20% of TaB2 and 10-15% of Sc2O3. In addition, the invention also provides a preparation method of the coating. TaB2 and Sc2O3 are added to make the melting point of an external layer oxidation product borosilicate glass to be risen, the viscosity of the borosilicate glass to be risen, the evaporation rate of the borosilicate glass to be reduced, the oxygen dispersion coefficient of the borosilicate glass to be reduced, an internal layer oxidation product ZrO2 phase to be stable, the melting point of ZrO2 to be risen, and the oxygen diffusion coefficient of ZrO2 to be reduced.

CN102674893A discloses an ultra-high temperature antioxidation coating for a carbon/carbon composite material. The ultra-high temperature antioxidation coating consists of ZrB2, MoSi2, TiB2 and LuB6 in certain percent by volume. The preparation method comprises the following steps that: the carbon/carbon composite material is ground, polished, cleaned and dried; the ZrB2, MoSi2, TiB2, LuB6 and the carbon/carbon composite material are put in an electron beam physical vapor deposition furnace; the carbon/carbon composite material is heated by electron beams; the ZrB2, MoSi2, TiB2 and LuB6 are evaporated by the electron beams; and gas molecules are deposited on the surface of the carbon/carbon composite materials to form a ZrB2-MoSi2-TiB2-LuB6 coating for the carbon/carbon composite material.

CN106587629A discloses a boride-modified glass ceramic-based composite high-temperature anti-oxidation coating, which is characterized in that the composite high-temperature anti-oxidation coating fired on the surface of the refractory metal substrate is composed of boride made of silicate glass. The boride content of the coating is 30% to 70% by mass, wherein the boride is one or two of HfB2, ZrB2 and TiB2.

The boride-modified glass-ceramic-based composite high-temperature anti-oxidation coating is characterized in that the silicate glass is composed of the following mass percentages of raw materials: B2O3 3-20%, Al2O3 2%-15%, ZrO2 3%-10%, compound M 3% to 5%, compound N 5% to 20%, the balance is SiO2; the compound M is CaO and/or SrO2; the compound N is one or both of KNO3, NaOH and ZnO more than one species.

The oxidation behaviour of diboride based UHTCs, including HfB2 and ZrB2, has been studied during the past 20 years. There have been several efforts in understanding the mechanisms of oxidation and degradation of baseline diborides at different temperature regimes. A main factor for increased oxidation kinetics at elevated temperatures can be found in the formation of cracks, pores and other defects within the oxide scale. ZrO2 and HfO2 show a phase transition, which is accompanied by a reduction in volume and the initiation of defects within the scale. The oxygen diffusion through pores and cracks is preferred compared to the diffusion through dense oxides. Therefore, the diffusivity of oxygen is increasing with the porosity, ending in reaction controlled parabolic oxidation kinetics for baseline diborides (transportation of oxygen through the oxide scale is much faster than the reaction of ZrB2→ZrO2 and B2O3). The liquid boria at the surface and inside the porous oxide scale inhibits the oxygen diffusion and decreases the parabolic oxidation rate constant. However, liquid boria starts to evaporate above 1000° C. and leaves behind the porous and unprotective oxide scale.

Researchers have been working on diboride based UHTC composites to achieve desired mechanical and oxidation resistant properties. Some common examples are the addition of secondary components such as SiC, WC, B4C or Nb. On the other hand, researchers reported the synthesis of high entropy UHTCs like (Ti0.2Zr0.2Nb0.2Hf0.2Ta0.2)B2 to profit from the symbiosis and synergies of all the single components. All in all, the developed ceramic composites are not stable enough to countervail the oxidation for exposure times above several minutes at elevated temperatures. The addition of secondary components can be regarded as temporary solutions with a lot of drawbacks in production processes.

For example, the addition of pure metallic Nb affects the stabilization of the overlaying boria glass, forming a liquid solution. The glass reduced the oxygen diffusion to the reaction front of the ceramic compound. Beneath the B2O3-Nb2O5 glass a porous ZrO2 scale with reacted grains of Nb2Zr6O17 is forming. Densification of the solid scale due to liquid phase sintering was not observed. Therefore, it can be assumed, once the glassy liquid solution evaporates above 1500° C., it will leave behind an unprotective mixed oxide scale, which will not prevent the oxygen diffusion to the reaction front of the ceramic compound.

The addition of tungsten carbide (WC) initiates the densification of the porous ZrO2 oxide scale by forming liquid WO3. During oxidation the WO3 liquid initiates liquid phase sintering of ZrO2-grains. However, due to the high evaporation rate of the WO3 liquid and the protective B2O3 liquid at elevated temperatures, the scale gets not fully densified.

No UHTC composite demonstrated reliable performance of a stable glass at elevated temperatures >1500° C. for exposure times >15 min until date. The most promising approach is the addition of silicon carbide (SiC). During oxidation, SiC oxidizes to CO2 and SiO2, forming a more stable glassy layer at the surface compared to B2O3. The SiO2-glass layer prevents the oxygen diffusion to the re-action front. However, at temperatures above 1300° C. the silica degrades and does not prevent the oxidation in a reliable way for long durations. In case of diboride based compositions, the resulting oxidation products are solid MO2 and liquid B2O3. The B2O3 evaporates at elevated temperatures, whereas the porous MO2 cannot prevent the oxygen diffusion to the reaction front, which leads to reaction controlled linear oxidation kinetics.

Therefore, there is a need for an easy, fast, cost effective and reliable slurry-based coating for diboride based ultra-high temperature ceramics, which prevents and/or minimizes the oxidation reactions of UHTC, and thus the formation of cracks and pores at the surface of the ceramic material, at high temperatures.

This background is provided as an illustrative contextual environment only. It will be readily apparent to those of ordinary skill in the art that the coatings and associated articles of manufacture, methods, and the like of the present disclosure may be implemented in other contextual environments as well.

### SUMMARY

The object of the present subject matter is to provide for an easy, fast, cost effective and reliable slurry-based coating for diboride based ultra-high temperature ceramics, which prevents and/or minimizes the oxidation reactions of UHTC, and thus the formation of cracks and pores at the surface of the ceramic material, at high temperatures.

To achieve the foregoing and other objects and advantages, in one aspect, the present subject matter is directed to a diboride based ultra-high-temperature ceramic comprising a directly applied coating, wherein the coating comprises a mixture of elemental aluminum and alumina mixtures.

In at least one embodiment, the mixture of elemental aluminum and alumina mixtures may have at least a content of 50 Vol. % of elemental aluminum powder in said mixture. Additionally or alternatively, the mixture of elemental aluminum and alumina mixtures may have at least a content of 60 Vol. % of elemental aluminum powder in said mixture. Additionally or alternatively, the mixture of elemental aluminum and alumina mixtures may have at least a content of 65 Vol. % of elemental aluminum powder in said mixture.

In an additional or alternative embodiments, the mixture of alumina mixtures and elemental aluminum may be applied as a slurry. In some such embodiments or different embodiments, a second oxidation product of the at least one metal boride is MO2. Additionally or alternatively, the thickness of formed MO2, which may include ZrO2, may be 50 μm or less after 1 h from 1400° C. to 1550° C. Additionally or alternatively, the thickness may be 40 μm or less after 1 h from 1400° C. to 1550° C. Additionally or alternatively, the thickness may be 30 μm or less after 1 h from 1400° C. to 1550° C. In an additional or alternative embodiment, the layer of formed MO2 may be less than 250 μm after 1 h from 1550° C. to 1650° C. Additionally or alternatively, the layer of formed MO2 may be less than 225 μm after 1 h from 1550° C. to 1650° C. Additionally or alternatively, the layer of formed MO2 may be less than 200 μm after 1 h from 1550° C. to 1650° C.

In at least one embodiment, the ultra-high-temperature ceramic may be based on at least one metal boride or mixtures thereof. In some embodiments, the at least one metal is selected from transition metals. Additionally or alternatively, a first oxidation product of the at least one metal boride may be B2O3. In some such embodiments or different embodiments, the at least one metal boride and/or B2O3 may react with the alumina mixtures to a reaction product. Additionally or alternatively, the at least one metal boride, B2O3, and/or the reaction product may form orthorhombic phases of aluminum. In additional or alternative embodiments, the reaction product may act as a protective layer. Additionally or alternatively, the protective layer may slow down the evaporation of B2O3. In additional or alternative embodiments, the coating may have a thickness of at least 200 μm after drying, such as at least 150 μm, such as at least 100 μm.

In some embodiments, the coating may be directly applied to a hypersonic or re-entry vehicle as at least one of a thermal protection system or sharp leading edge. Additionally or alternatively, the coating may be directly applied to power reactors for thermal energy management. In some such embodiments or different embodiments, the diboride based ultra-high-temperature ceramic may be essentially free of carbides.

In an additional or alternative aspect, the present subject matter is directed to a method of preparing a protective layer on a diboride based ultra-high-temperature ceramic. The method includes roughening the surface of an ultra-high-temperature ceramic material. The method further includes preparing a coating comprising a mixture of elemental aluminum and alumina mixtures as a slurry. The method also includes applying the slurry to at least one surface of the ultra-high-temperature ceramic material.

In at least one embodiment, the slurry may be prepared with at least one of alcohol, volatile alcohol, or isopropanol alcohol.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 shows the oxidation mechanisms of baseline ZrB2 in the low, intermediate, an elevated temperature regime without any modification of the ceramic mate-rial and/or applied coatings;

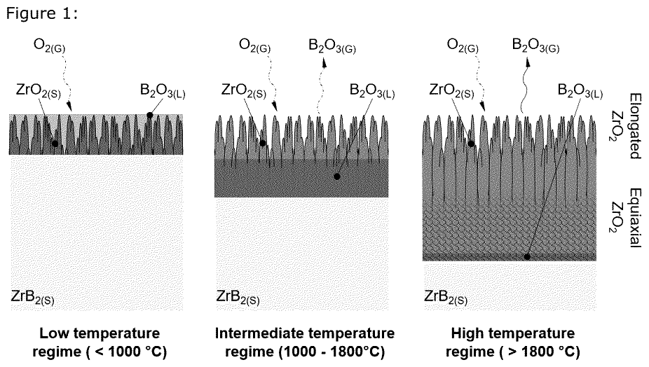

FIGS. 2 a) and b) show the BSE (backscattered electrons) microscopy-cross sectional micrographs of baseline ZrB2 after oxidation at 1500° C. and 1600° C. for 1 h without an applied coating as comparative examples;

FIG. 3 shows the BSE) microscopy-cross sectional micrographs of the coating after drying; and

FIGS. 4 a) and b) show the BSE (backscattered electrons) microscopy-cross sectional micrographs of baseline ZrB2 with a coating according to aspects of the present subject matter after oxidation at 1500° C. and 1600° C. for 1 h.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In several embodiments of the present subject matter, the underlying problem is solved by a diboride based ultra-high-temperature ceramic comprising a directly applied coating, wherein the coating comprises a mixture of elemental aluminum and alumina mixtures. Thus, the embodiments of the present subject matter inhibit the oxygen diffusion to the reaction front of diboride based UHTCs (Ultra High Temperature Ceramics).

According to aspects of the present subject matter, alumina mixtures is only α-aluminum oxide (α-Al2O3). This means that, according to aspects of the present subject matter, alumina oxide, alumina mixtures and Al2O3 are synonyms and have the same meaning, namely that these terms refer to α-Al2O3. Since it is used as a refractory material with a melting point at ˜2072° C., both binary ceramic compositions, namely Al2O3-MB2 and Al2O3-MO2, are inert and will not react with each other, wherein M is a transition metal. Therefore, Al2O3 was not in the focus of interest in the prior art.

It was surprisingly found that liquid B2O3, formed by the oxidation of the diboride metal ceramic, reacts with Al2O3 and forms a complex orthorhombic phase of Al18B4O33 or Al4B2O9, which prevents and/or minimizes the oxidation reaction of the diboride based ultra-high temperature ceramic material. This happens during the use of the diboride based ceramic at high temperatures.

The coating as applied comprises the respective mixture of elemental aluminum and alumina. During use of the diboride-based ceramic with the inventive coating, the metallic aluminum oxidizes, which results in the formation of alumina (Al2O3). This alumina reacts during use with the boria (B2O3), forming a more resistant glass at the surface. Thus, directly after production, the coating comprises the mixture of elemental aluminum and alumina. During use, this is transferred by chemical reaction to a glass resulting from the reaction between alu-mina and boria.

The combination of alumina and aluminum is essential, as the oxidation of this coating occurs prior to the formation of boria. This ensures the formation of the glass by the reaction of alumina and boria. Thus, the protection arises from two steps, namely a first step in which the alumina-aluminum-coating oxidizes—which prevents rapid oxidation. And a second step, the immediate reaction of boria with the alumina at the reaction front of the diboride based UHTC to a more protective glass-like compound prior to boria is to evaporate.

In the following, preferred embodiments of the diboride based ultra-high-temperature ceramic comprising a directly applied coating as well as a method of manufacturing such a ceramic material comprising the coating are further described, whereby all features can be combined with each other in any manner with each other and do not limit the diboride based ultra-high-temperature ceramic according to the present subject matter or the method of the providing it.

According to aspects of the present subject matter, an ultra-high-temperature ceramic is a refractory ceramic that can withstand extremely high temperatures without degrading. Furthermore, the ultra-high-temperature ceramic may be abbreviated as UHTC and has the same meaning. Furthermore, ultra-high-temperature ceramic, or UHTC, may be referred as ceramic material, which are synonyms and have the same meaning herein.

According to this preferred embodiment “based on” means that at least one di-boride or mixture thereof has at least a content of 50 vol. %, preferably 60 vol. %, more preferably 70 vol % based on to the total volume of the UHTC.

According to aspects of the present subject matter, the coating may be directly applied to the material as an overlay coating, which is the diboride based UHTC. Directly applied in the sense of the present subject matter means that there is no other layer of materials or compounds between the coating and the ceramic material at the time of application of the coating to the ceramic material. Thus, the coating has direct contact to the applied surface of the ceramic material at the time of application. When referring to aspects of the present subject matter, the direct applied coating comprises a mixture of elemental aluminum and alumina mixtures.

According to aspects of the present subject matter, the coating raw material may include a mixture of elemental aluminum and alumina mixtures. In a preferred embodiment, the mixture of elemental aluminum and alumina mixtures has at least a content of 50 vol. %, more preferably 60 vol. %, most preferably 65 vol. % of elemental aluminum powder in said mixture. The coating may further comprise common impurities such as metals and/or their oxides and/or mixtures thereof but are not limited to, such as iron, iron oxides (II or III), silicon, silica, (earth) alkali oxides, arsenic, arsenic oxide, and/or minerals. Impurities according to the present subject matter means that the compounds may be present in the coating with an amount less than 1%, preferably less than 0.5%, more preferably less than 0.1% by weight when referring to the total weight of the coating.

Preferably the particles of the coating raw material have a size of 0.05 μm to 20 μm, preferably 0.5 μm to 20 μm, more preferably 1 μm to 10 μm for the aluminum particles and/or 1 μm or less, preferably 0.5 μm or less, more preferably 0.1 μm or less for the alumina mixtures particles. Particle sizes for both sub-stances, aluminum and/or alumina mixtures can be obtained by spray atomization and/or ball milling.

In another preferred embodiment according to aspects of the present subject matter, alumina mixtures particles are smaller than aluminum particles in the coating.

Yet in another preferred embodiment according to aspects of the present subject matter, the coating may have a ratio of aluminum to alumina mixtures (Al:Al2O3) of 0.05 to 10, preferably 0.1 to 0.5 when referring to the content of both substances in the coating.

According to another preferred embodiment, the coating comprises additionally at least one solvent before and/or while applied to the surface of the ceramic material, thus being a slurry. Preferably the at least one solvent is an organic solvent, more preferably an organic solvent with a low boiling point and/or vapor pressure to ensure quick evaporation of the solvent after application on the surface. More preferably the at least one solvent is selected from the group of alcohols, acetates or aldehydes, such as isopropanol, methanol, ethanol, ethyl acetate, acetone and or mixtures thereof. After application of the slurry, the slurry is dried, and the coating is formed. Additionally, preferably the solvent is only one solvent selected from the group described above.

Therefore and according to aspects of the present subject matter, another preferred embodiment is the diboride based ultra-high-temperature ceramic, wherein the mixture of alumina mixtures and aluminum is applied as a slurry.

Furthermore and in another preferred embodiment, the slurry comprises at least one alcohol, preferably at least one volatile alcohol, more preferably isopropanol.

In a more preferred embodiment, the coating consists of elemental aluminum, alumina mixtures and at least one solvent selected from the list above. Thus, the coating is also a slurry when applied in a preferred embodiment according to aspects of the present subject matter. Additionally, in a preferred embodiment, the total amount of potential impurities as listed above may be less than 0.5% by weight when referring to the total weight of the coating. This content of impurities may refer to the coating with and/or without solvent.

Accordingly, the weight ratio in the above-mentioned preferred embodiment refers to the dry mixture of elemental aluminum and alumina mixtures, which has at least a content of 50 vol. %, more preferably 60 vol. %, most preferably 65 vol. % of elemental aluminum powder in said mixture without the solvent of the slurry.

Furthermore and in a preferred embodiment, the coating as applied is essentially free of any other oxidic materials (i.e., metal oxides, alkaline (earth) metal oxides, etc.). In a preferred embodiment, the coating is essentially free of silica (SiO2). Essentially free, within the meaning of this context, means that the content of the oxidic materials in the coating is less than 1 weight %, preferably less than 0.5 weight % when referring to the total weight of the coating. This content of silica may refer to the coating with and/or without solvent.

Additionally, in another preferred embodiment, the coating consists of aluminum and alumina mixtures.

In another preferred embodiment, the diboride based ultra-high temperature ceramic on which the coating is applied is based on at least one metal boride or mixtures thereof, wherein the at least one metal is selected from transition metals. The at least one transition metal is selected from the group consisting of d-block elements, preferably selected from Sc, Ti, V, Cr, Mn, Ni, Y, Zr, Nb, Mo, Pd, Tc, Lu, Hf, Ta, W, Pt and or mixtures thereof more preferably selected from Ni, Ti, Nb, Mo, Zr, Hf and or mixtures thereof. Thus, in one preferable embodiment, the coating is applied to a ceramic material, which is based on at least on ZrB2, HfB2, TiB2, NiB2, MoB2 and/or mixtures thereof. According to this preferred embodiment “based on” means that the at least one transition metal boride or mixtures thereof has at least a content of 50 vol. %, preferably 60 vol. %, more preferably 70 vol % based on to the total volume of the UHTC.

In another preferred embodiment according to aspects of the present subject matter, the diboride based ultra-high-temperature ceramic is exposed to a high temperature. High temperature in the sense of the present subject matter means a temperature of at least 1000° C., more preferably at least 1300° C., most preferably at least 1500° C., even more preferably at least 1600° C. In another preferred, the diboride based ultra-high-temperature ceramic may be used at a high temperature.

The coating according to aspects of the present subject matter unfolds its technical effect as soon as the ultra-high-temperature ceramic is exposed to high temperatures in which the undesired oxidation effect of the diboride occurs. When the ultra-high-temperature ceramic is exposed to high as described above, following oxidation reaction will occur:

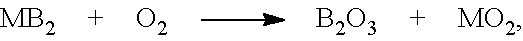

wherein MB2 refers to at least one metal boride or mixtures thereof of the
ultra-high-temperature ceramic and is selected as described above.

The exposure temperature determines the kinetics of the reaction, so that higher temperature more and faster oxidation products will be formed.

In another preferred embodiment, the diboride based ultra-high-temperature ceramic may form a first oxidation product of the at least one metal boride, which is B2O3 and reacts with the alumina mixtures to a reaction product. Without being bound to theory, in this preferred embodiment, the reaction product is preferably forming orthorhombic phases of aluminum, which more preferably may be characterized with the molecular formula of Al18B4O33 and/or Al4B2O9.

In another preferred embodiment, the second oxidation product of the at least one metal boride is MO2. In this preferred embodiment, M of MO2 is preferably selected from the transition metals listed above. Most preferably MO2 is selected from the group consisting of ZrO2, HfO2, TiO2, NiO, MoO2 and/or mixtures thereof.

However, it should be mentioned that, according to aspects of the present subject matter, the formation of the second oxidation product is undesired and is supposed to be prevented. Yet oxidation cannot be prevented completely, and aspects of the present subject matter may require some amount of undesired oxidation products.

In another preferred embodiment, the reaction product acts as a protective layer, which essentially prevents evaporation of B2O3, i.e. the evaporation of B2O3 which occurs at high temperature. The evaporation of B2O3 cannot be completely prevented, but the evaporation rate is significantly reduced, so that a longer lifetime is possible. The reaction product between the coating and the surface of B2O3, which is formed underneath the coating, is a porous mixed oxide phase with “snowflake-like” appearance, forming a reaction zone, formed by B2O3 and Al2O3, at the surface. The reaction zone may act like a closed-cell “sponge” and prevent the boron oxide evaporation by capillary effects. The inhibited boron oxide evaporation and the reaction of the oxides to solid products reduce the oxygen diffusion to the oxidation front and decreases the oxidation of the underlying MB2.

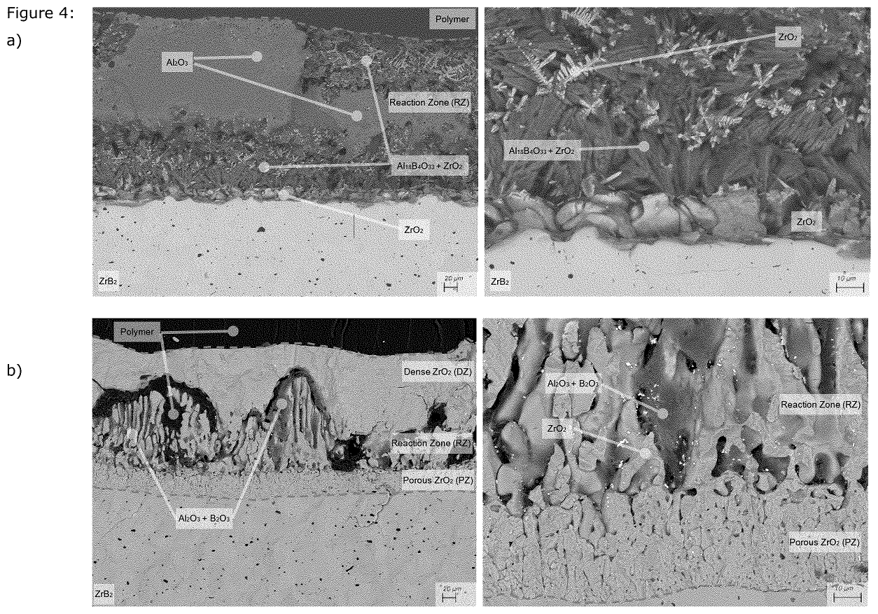

As oxidation progresses, the first oxidation product, liquid B2O3, will react with the coating according to aspects of the present subject matter. The reaction will inhibit or at least significantly slow down the B2O3 evaporation due to the Al2O3-layer and the formed solid mixed oxides within the reaction zone (see FIGS. 4 a) and b)); the oxidation will be inhibited due to decreased oxygen diffusion. Due to the increasing boria content during oxidation the solid solutions will transform to liquid solutions with respect to the time according to the Al2O3-B2O3 phase diagram.

In another preferred embodiment according to aspects of the present subject matter, the diboride based ultra-high-temperature ceramic forms a second oxidation product MO2, wherein MO2 is preferably selected from the group consisting of ZrO2, HfO2, TiO2, NiO, MoO2 and/or mixtures thereof, more preferably ZrO2, with a thickness of 50 μm or less, preferably 40 μm or less, more preferably 30 μm or less after 1 h, more preferably 2 h or most preferably 3 h from 1400° C. to 1550° C., preferably from 1450° C. to 1525° C., most preferably at 1500° C. Any combination of thickness of formed MO2, wherein MO2 is preferably selected from the group consisting of ZrO2, HfO2, TiO2, NiO, MoO2 and/or mixtures thereof, more preferably ZrO2, time and/or temperature range is encompassed by this preferred embodiment. This means, once the diboride based ultra-high-temperature ceramic is exposed to a temperature of at least 1400° C. to 1550° C. for at least 1 h, the thickness of the formed metal oxide is equal or less than 50 μm, preferably equal or less than 40 μm, more preferably equal or less than 30 μm.

In another preferred embodiment according to aspects of the present subject matter, the diboride based ultra-high-temperature ceramic forms a second oxidation product MO2, wherein MO2 is preferably selected from the group consisting of ZrO2, HfO2, TiO2, NiO, MoO2 and/or mixtures thereof, more preferably ZrO2, with a thickness of 250 μm or less, preferably 225 μm or less, more preferably 200 μm or less after 1 h, more preferably 2 h or most preferably 3 h from 1550° C. to 1650° C., preferably from 1575° C. to 1625° C., most preferably at 1600° C. Any combination of thickness of formed ZrO2, time and/or temperature range is encompassed by this preferred embodiment. This means, once the diboride based ultra-high-temperature ceramic is exposed to a temperature of at least from 1550° C. to 1650° C. for at least 1 h, the thickness of the formed metal oxide is equal or less than 250 μm, preferably equal or less than 225 μm, more preferably equal or less than 200 μm.

In another preferred embodiment, the diboride based ultra-high-temperature ceramic may have a thickness of the dried yet unreacted coating of at least 200 μm, 150 μm, or 100 μm.

The diboride based ultra-high-temperature ceramic comprising the coating according to aspects of the present subject matter is able to reduce the oxide formation by up to 90% compared to baseline of the diboride at 1500° C. after 1 h. Preferably the oxidation is inhibited by at least 60%, more preferably 70%, more preferably 80% most preferably by 85% compared to baseline of the diboride at 1500° C. after 1 h, preferably after 2 h, more preferably after 3 h. All possible combinations are encompassed by the preferred embodiments according to aspects of the present subject matter.

Furthermore, the diboride based ultra-high-temperature ceramic comprising the coating according to aspects of the present subject matter is able to reduce the oxide formation by up to 50% compared to baseline of the diboride at 1600° C. after 1 h. Preferably the oxidation is inhibited by at least 20%, more preferably 30%, more preferably 35% most preferably by 40% compared to baseline of the diboride at 1500° C. after 1 h, preferably after 2 h, more preferably after 3 h. All possible combinations are encompassed by the preferred embodiments according to aspects of the present subject matter.

Without being bound theory, it is believed that once the diboride based ultra-high-temperature ceramic comprising the coating is brought into high temperature, the formed second oxidation product may be soluble in the first oxidation product, namely the B2O3. Thus, the second oxidation product may precipitate out of the liquid B2O3 and form crystals. These crystals may function as a further protective layer, since the slow precipitation will form a dense and packed layer, which is not porous, and oxygen diffusion will be reduced significantly.

Thus and in another preferred embodiment according to aspects of the present subject matter, the protective layer formed by the applied coating on the diboride based ultra-high-temperature ceramic may comprise the second oxidation product.

According to aspects of the present subject matter, a method is also disclosed which is used to prepare a protective coating for a diboride based ultra-high-temperature ceramic, wherein the method comprising:
a) roughening the surface of a diboride based ultra-high-temperature ceramic material;
b) preparing a coating comprising a mixture of elemental aluminum and alumina mixtures as a slurry; and/or
c) applying the slurry from b) to at least one surface of a).

The surface of the diboride based ultra-high-temperature ceramic may be roughened by standard methods known in the art to increase the slurry infiltration.

The diboride based ultra-high-temperature ceramic may be described as above in accordance with aspects of the present subject matter. The prepared slurry, comprising elemental aluminum, alumina mixtures and a solvent, may also be described as above in accordance with aspects of the present subject matter. The slurry is then applied to the surface of the roughened diboride based ultra-high-temperature ceramic 1 in step a).

In a preferred embodiment of the method to prepare a protective coating for a diboride based ultra-high-temperature ceramic material, the slurry may be dried with standard methods known in the art.

In another preferred embodiment, the slurry, which becomes the protective layer after exposure at high temperatures, may be prepared with at least one alcohol, preferably at least one volatile alcohol, more preferably isopropanol. In accordance with aspects of the present subject matter, the slurry prepared according to the method may also be prepared with an organic solvent with a low boiling point and/or vapor pressure to ensure quick evaporation after application on the surface. More preferably, the solvent is selected from the group of alcohols, acetates or aldehydes, such as isopropanol, methanol, ethanol, ethyl acetate, acetone and or mixtures thereof.

In another preferred embodiment according to aspects of the present subject matter, the coating may be used as a protective layer for a diboride based ultra-high-temperature ceramic.

The exceptional properties make the diboride based ultra-high-temperature ceramic comprising the directly applied coating perfect for the use in different technological areas. For instance, the diboride based ultra-high-temperature ceramic according to aspects of the present subject matter may be used as thermal protection system and/or sharp leading edges of hypersonic or re-entry vehicles. In another preferred embodiment, the diboride based ultra-high-temperature ceramic according to aspects of the present subject matter may be used as materials in power reactors for thermal energy management.

In another preferred embodiment, the diboride based ultra-high-temperature ceramic according to aspects of the present subject matter may be essentially free of carbides. In accordance with this embodiment, the ceramic material and/or the coating may be essentially free of carbon before exposing the material to high temperatures, in accordance with aspects of the present subject matter. Essentially free of carbides means that there is less than 5%, preferably 1%, most preferably less than 0.5% carbides by weight in the material or in the coating. Carbides are metal carbon composites and well known in the art.

Yet in another preferred embodiment according to aspects of the present subject matter, the use of an orthorhombic phase comprising alumina as a protective layer is covered.

### EXAMPLES

### Exposure of the Diboride Based Ultra-High-Temperature Ceramic Without the Coating

### Production of Diboride Based Ultra-High-Temperature Ceramics via Hot Pressing

A ceramic material based on ZrB2 was exposed at 1500° C. and 1600° C. for one hour without any protective coating. The materials have been prepared by hot pressing using commercial ZrB2 powders (Grade B, HC Starck) and 0.5 wt % carbon as a sintering aid. Hot pressed billets were cut by electrical discharge machining (Agiecut 150 HSS, 0.3 mm wire, copper) into rectangular specimens with a size of 12 by 12 by 3 mm. All surfaces were ground using diamond abrasive size of 10 μm to avoid a possible contamination by copper during EDM machining. The densities of the specimens were measured as >95% and the average grains size was measured as 19+13 um.

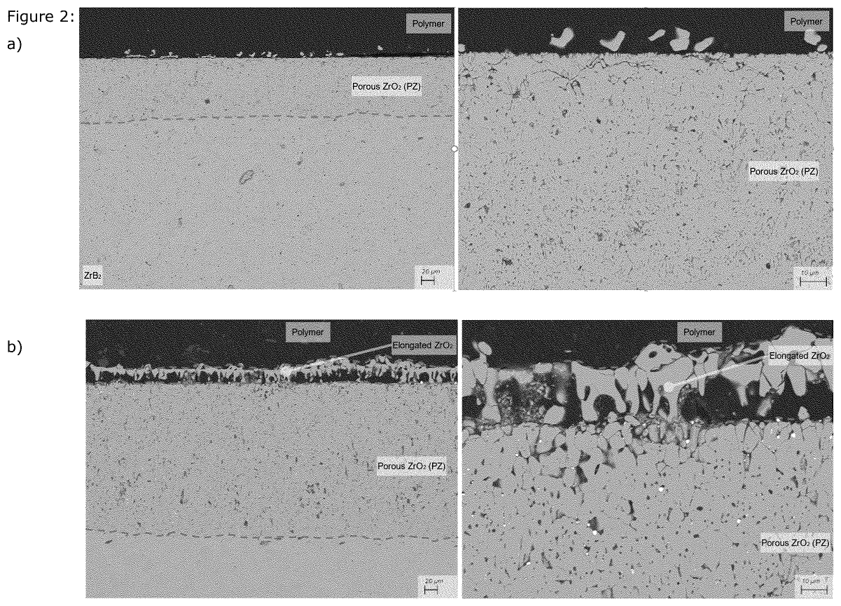

Hot Pressing or Spark Plasma Sintering. Oxidized specimens were analysed by SEM, EDS, and XRD. In both cases, no residue of the first oxidation product, namely B2O3, was found. The high magnification micrographs show the porous ZrO2 oxide scale on top of ZrB2 (FIGS. 2 a) and b)). An average oxide scale of ˜94 μm was measured for 1500° C. after one hour (FIG. 2 a)), whereas ˜286 μm was measured for 1600° C. for similar exposure time (FIG. 2 b)). The oxidation kinetics increase with the temperature.

### Preparation of the Coating as a Slurry and Application on Diboride Based Ultra-High Temperature Ceramic

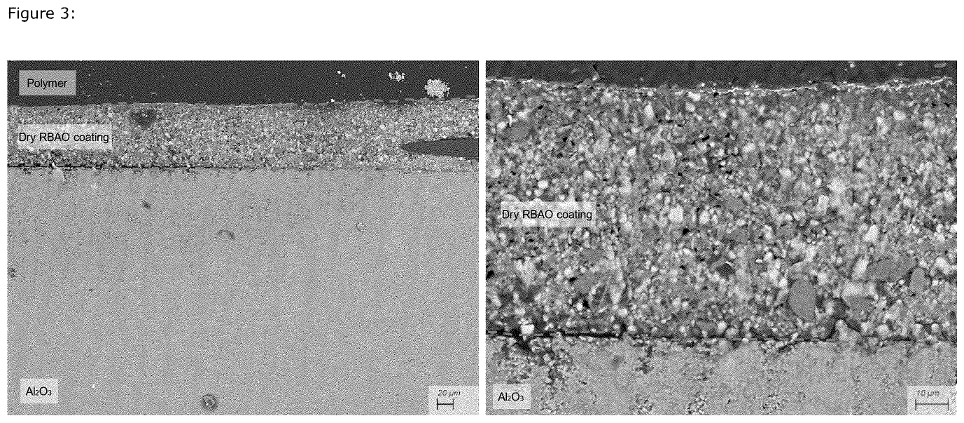

The RBAO slurry was prepared by ball milling of 65 vol % aluminum powder and 35 vol % Al2O3 powder. After ball milling, the powder mixture was suspended in isopropanol. Rectangular baseline ZrB2 with the dimension of 12 by 12 by 3 mm were ground by 10 μm grit size to increase the surface roughness for improved slurry infiltration and to avoid a possible contamination by copper during EDM machining. Similar weight per mm² of homogeneous slurry was applied for comparable coating thickness. A thickness of around 75 μm was measured after the slurry was dried (FIG. 3).

### Exposure and Analysis of the Diboride Based Ultra-High-Temperature Ceramic With/Without the Protective Coating

High temperature oxidation at 1500° C. and 1600° C. was performed in a tube furnace (Carbolite Gero, RHTH 120/300/16, England), equipped with a gas tight Al2O3 tube. Synthetic air was used to flush the tube with 0.4 l/min during oxidation (gas velocity of ˜0.25 m/min). Specimens of diboride based ultra-high-temperature ceramics with/without coating were placed on Al2O3 powder with an average grain size of 4.7 um (Nabolax No 625-31), poured into an Al2O3 crucible with a size of 12*70*9 mm. The loaded crucible was pushed in the center of the preheated tube and subsequently quenched into ambient air after a pre-scribed oxidation time.

Crystalline Phases at the surface were analysed by X-Ray Diffraction (XRD). Metallographic standard processes were used to prepare a polished cross-section of the specimens. SEM, equipped with a Back Scatter Electron Detector (BSE), was used to analyse the cross-sections (DSM Ultra 55; Carl Zeiss NTS, Wetzlar, Germany). SEM was equipped with Energy Dispersive X-Ray Spectroscopy (EDS), which was used to analyse the chemical composition of the formed oxide scales (Inca; Oxford Instruments, Abingdon, England).

For uncoated ZrB2, no residue of the glassy oxidation product, namely B2O3, was found at the surface. The high magnification micrographs show the porous ZrO2 oxide scale on top of ZrB2 (FIGS. 2 a) and b)). An average oxide scale of ˜94 um was measured for 1500° C. after one hour (FIG. 2 a)), whereas ˜286 μm was measured for 1600° C. for similar exposure time (FIG. 2 b)). The oxidation kinetics increase with the temperature.

The RBAO coatings on ZrB2 react to a continuous layer of α-Al2O3 in the initial exposure time. Afterwards the formed B2O3 reacts with the Al2O3 to complex orthorhombic phases like Al18B4O33 or Al4B2O9. (FIGS. 4 a) and b)). Referring to FIG. 4 a) (1500° C.) the area of the coating can be seen as the reaction zone (RZ) containing crystals of ZrO2, which precipitate out of the liquid B2O3. Referring to FIG. 4 b) (1600° C.) the RBAO coating reacts to α-Al2O3. Simultaneously, a growing amount of B2O3 forms during accelerated oxidation of ZrB2 at elevated temperatures. It is assumed that the increased boria formation in the initial oxidation time promotes the formation of liquid solutions with reduced evaporation rate (compared to pure boria) rather than the formation of solid mixed oxides. Zirconia precipitates out of the liquid and dominates the oxidized surface. However, sintering effects due to stabilized B2O3-Al2O3 liquid may initiate sintering effects and the densification of the uppermost zirconia scale. Residual B2O3-Al2O3 glass was found within the oxide scale, which confirms the functionality of the coating even at 1600° C. after 1 h of oxidation (see FIG. 6).

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A diboride based ultra-high-temperature ceramic comprising a directly applied coating, wherein the coating comprises a mixture of elemental aluminum and alumina mixtures.

2. The diboride based ultra-high-temperature ceramic according to claim 1, wherein the mixture of elemental aluminum and alumina mixtures has at least a content of 50 Vol. % of elemental aluminum powder in said mixture.

3. The diboride based ultra-high-temperature ceramic according to claim 1, wherein the mixture of elemental aluminum and alumina mixtures has at least a content of 60 Vol. % of elemental aluminum powder in said mixture.

4. The diboride based ultra-high-temperature ceramic according to claim 1, wherein the mixture of elemental aluminum and alumina mixtures has at least a content of 65 Vol. % of elemental aluminum powder in said mixture.

5. The diboride based ultra-high-temperature ceramic according to claim 1, wherein the mixture of alumina mixtures and elemental aluminum is applied as a slurry.

6. The diboride based ultra-high-temperature ceramic according to claim 5, wherein a second oxidation product of the at least one metal boride is MO2.

7. The diboride based ultra-high-temperature ceramic according to claim 6, wherein the thickness of formed MO2, comprising ZrO2, is 50 μm or less after 1 h from 1400° C. to 1550° C.

8. The diboride based ultra-high-temperature ceramic according to claim 6, wherein the thickness of formed MO2, comprising ZrO2, is 40 μm or less after 1 h from 1400° C. to 1550° C.

9. The diboride based ultra-high-temperature ceramic according to claim 6, wherein the thickness of formed MO2, comprising ZrO2, is 30 μm or less after 1 h from 1400° C. to 1550° C.

10. The diboride based ultra-high-temperature ceramic according to claim 6, wherein the layer of formed MO2, comprising ZrO2, is less than 250 μm after 1 h from 1550° C. to 1650° C.

11. The diboride based ultra-high-temperature ceramic according to claim 6, wherein the layer of formed MO2, comprising ZrO2, is less than 225 μm after 1 h from 1550° C. to 1650° C.

12. The diboride based ultra-high-temperature ceramic according to claim 6, wherein the layer of formed MO2, comprising ZrO2, is less than 200 μm after 1 h from 1550° C. to 1650° C.

13. The diboride based ultra-high-temperature ceramic according to claim 1, wherein the ultra-high-temperature ceramic is based on at least one metal boride or mixtures thereof, wherein the at least one metal is selected from transition metals.

14. The diboride based ultra-high-temperature ceramic according to claim 13, wherein a first oxidation product of the at least one metal boride is B2O3, which reacts with the alumina mixtures to a reaction product, which forms orthorhombic phases of aluminum.

15. The diboride based ultra-high-temperature ceramic according to claim 14, wherein the reaction product acts as a protective layer, which slows down the evaporation of B2O3.

16. The diboride based ultra-high-temperature ceramic according to claim 1, wherein coating has a thickness of at least 200 μm after drying.

17. The diboride based ultra-high-temperature ceramic according to claim 1, wherein coating has a thickness of at least 150 μm after drying.

18. The diboride based ultra-high-temperature ceramic according to claim 1, wherein coating has a thickness of at least 100 μm after drying.

19. The diboride based ultra-high-temperature ceramic according to claim 1, wherein the coating is directly applied to a hypersonic or re-entry vehicle as at least one of a thermal protection system or sharp leading edge.

20. The diboride based ultra-high-temperature ceramic according to claim 1, wherein the coating is directly applied to power reactors for thermal energy management.

21. The diboride based ultra-high-temperature ceramic according to claim 1, wherein the diboride based ultra-high-temperature ceramic is essentially free of carbides.

22. A method of preparing a protective layer on a diboride based ultra-high-temperature ceramic, wherein the method comprising:
roughening the surface of an ultra-high-temperature ceramic material;
preparing a coating comprising a mixture of elemental aluminum and alumina mixtures as a slurry; and
applying the slurry to at least one surface of the ultra-high-temperature ceramic material.

23. The method of claim 22, wherein the slurry is prepared with at least one of alcohol, volatile alcohol, or isopropanol alcohol.
